(19) United States
(12) Patent Application Publication
(10) Pub. No.: US 2015/0248498 A1
(43) Pub. Date: Sep. 3, 2015

(54) Method of Delivering Customizable Personalized Digital Events from a Single Scannable Two-Dimensional Barcode by Executing Computer-Executable Instructions Stored On a Non-Transitory Computer-Readable Medium

(71) Applicant: LAWRENCE KWANG HAN, SINGAPORE (SG)

(72) Inventor: LAWRENCE KWANG HAN, SINGAPORE (SG)

(21) Appl. No.: 14/703,860

(22) Filed: May 4, 2015

Related U.S. Application Data
(63) Continuation-in-part of application No. 13/956,058, filed on Jul. 31, 2013, now abandoned.
(60) Provisional application No. 61/678,416, filed on Aug. 1, 2012.

(51) Int. Cl. G06F 17/30

(52) U.S. Cl. CPC G06F 17/30879

(57) ABSTRACT

A method of delivering customizable personalized digital events from a single scannable two-dimensional barcode utilizes a variety of variables and customization to enable dynamic delivery of digital events to users upon scanning a QR code. The same digital event or different digital events may be delivered to the same user or different users at the same location or different location from the same QR code. Administrators may define desired event trigger parameters in order to customize event delivery. User information is processed on-device and is not transmitted.

The current application is a continuation-in-part and claims priority to a non-provisional application Ser. No .13/956,058 filed on Jul. 31, 2013. The non-provisional application Ser. No. 13/956,058 claims priority to a provisional application 61/678,416 filed on Aug. 1, 2012.

### FIELD OF THE INVENTION

The present invention relates generally to applications for mobile electronic devices. More particularly, the present invention relates to a mobile device application for delivering customizable personalized events from a single QR code.

### BACKGROUND OF THE INVENTION

Advertising is a form of communication for marketing and is used to encourage, persuade, or manipulate an audience (viewers, readers, or listeners) to continue an action or to take some new action. More commonly, the desired result is to drive consumer behavior with respect to commercial offering, although political and ideological advertising is also common. The purpose of advertising may also be to reassure employees or shareholders that a company is viable or successful.

Many methods of advertising exist, including wall painting, billboards, flyers, cinema and television advertisements, internet banners, bus stop benches, magazines, and newspapers. Some printed advertisements include a Quick Response code, or QR code, which is a two-dimensional barcode which records information in an array of pixels and which can be decoded with appropriate software. The QR code system was first designed for the automotive industry in Japan, but has become popular outside the automotive industry due to its fast readability and greater storage capacity compared to standard Universal Product Code (UPC) barcodes. A QR code consists of black square dots arranged in a square grid on a white background, which can be read by an imaging device, such as a camera, and processed using appropriate software until the image can be appropriately interpreted. Typical use of a QR code means scanning the QR code, after which data is extracted from patterns present in both horizontal and vertical components of the image. An event is triggered immediately after each successful decode. Events triggered by a QR code may include displaying a text message, downloading and displaying informative materials, playing video or music online, displaying contents of a website or interacting with another application, or other purposes.

Originally designed for industrial uses, QR codes have become common in consumer advertising. Typically, a smartphone or other mobile device such as a tablet is used as a QR-code scanner, displaying the code and converting it to some useful form (such as a standard URL for a website, thereby obviating the need for a user to type it manually into a web browser). In the shopping industry, knowing what causes the consumers to be motivated when approaching products by the use of QR codes, advertisers and marketers can use the behavior of scanning to get consumers to buy, causing it to have the best impact on ad and marketing design. As a result, the QR code has become a focus of advertising strategy, since it provides quick and effortless access to the brand's website. Beyond mere convenience to the consumer, the importance of this capability is that it increases the conversion rate (that is, increases the chance that contact with the advertisement will convert to a sale), by coaxing qualified prospects further down the conversion funnel without any delay or effort, bringing the viewer to the advertiser's site immediately, where a longer and more targeted sales pitch may continue.

Since many different kinds of people exist with widely varying interests, it is desirable to tailor advertisements to more closely identify with the individual traits of the people being advertised to. Traditionally, advertising has largely been relegated to static advertisements, such as an image printed in a newspaper or on a billboard. It is possible to create advertisements that dynamically reflect the interests of the viewer by previously gathering information about the viewer; however, some consumers value their privacy and do not want personal information revealed to companies.

The present invention is intended to be implemented as an application on a mobile device. Many mobile device applications exist which can read QR codes; however, existing applications may at-most act only as intermediaries to capture, store and post-process information remotely on internet servers.

With the present invention, individual information is contained within the user's mobile device while processed or recoded and unidentifiable information is used or relayed to trigger events. With this invention, the same QR code also allows different events to be triggered based on the different unidentifiable information relayed, and also by customizable preferences defined by administrators of various businesses or locations. The result is that a user can provide personal information which is useful in relaying personalized advertisements or other digital events, without disclosing the user's personal information.

### BRIEF DESCRIPTION OF THE DRAWINGS

FIG. 1 is a stepwise flow diagram describing the general process of the present invention.

FIG. 2 is a stepwise flow diagram describing steps for utilizing location as a variable.

FIG. 3 is a stepwise flow diagram describing steps for categorizing user attributes into demographic groups and generating an event activation code.

FIG. 4 is a stepwise flow diagram describing steps for computing the event activation code.

FIG. 5 is a stepwise flow diagram describing additional steps for computing the event activation code and interpreting the event activation code.

FIG. 6 is a stepwise flow diagram describing steps for utilizing other variables as trigger inputs.

FIG. 7 is a stepwise flow diagram describing steps for utilizing a scan sequence event.

FIG. 8 is a stepwise flow diagram describing steps for utilizing a location change event.

FIG. 9 is a stepwise flow diagram describing steps for utilizing a personalizable digital event template.

FIG. 10 is an example table of event activation codes.

FIG. 11 is an example table of users.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The object of the present invention is to provide targeted or personalized advertising or other personalized digital events to a user through the user's smartphone. The present invention is preferably embodied as an application or program on a smartphone, tablet or other mobile device. Hereinafter, it should be understood that “smartphone” may be interchanged with “tablet or other mobile device”. The goal of the present invention is to enable businesses or other administrators to customize and deliver various digital events based on many variables including, but not limited to, user attributes, location, time of day, sequences, and randomness.

The goal of the present invention is to create a series of predetermined user profiles defined by specified user characteristics. As individual users install and use this application they will be categorized according to their characteristics into one of the predetermined user profiles.

The present invention is a method for delivering personalized digital events by scanning a single two-dimensional barcode. In the preferred embodiment of the present invention, the two-dimensional barcode is a Quick Response code, commonly known as a QR code. In the present invention, a single QR code provides the capability to deliver personalized or otherwise targeted advertisements, text messages or other digital events to a user's smartphone, whereas currently only one static digital event may be triggered by a QR code. In the preferred embodiment of the present invention, a smartphone application must be installed on a user's smartphone to utilize the present invention, and a dynamic QR code that has been enabled to provide multiple possible digital events must be provided in order to work with the present invention. In reference to the dynamic QR code, the “dynamic” qualifier is added because the dynamic QR code is capable of triggering one of multiple digital events (in conjunction with the present invention), whereas a traditional QR code may be thought of as static, as the traditional QR code is only able to trigger one event.

It should be noted that although the dynamic QR code is described as being dynamic, the dynamic QR code is not technically dynamic, because the dynamic QR code may initiate an event by calling a static website address with a variable incorporated into the address. For example, the dynamic QR code may call “www.abc123.com/x”, where x is a variable added by the smartphone application of the present invention, so strictly speaking the dynamic QR code is not itself necessarily functionally dynamic. Additionally, the dynamic QR code may initiate events according to administrator parameters. These parameters are defined by the administrator and stored preferably on a server or other accessible data storage, which the system accesses in order to determine what event to deliver to the user.

To use the present invention, the user initiates the smartphone application, enters personal information into the smartphone application, and then scans a dynamic QR code with the smartphone application. The smartphone application processes the user's information and retrieves the administrator's customization parameters, which are used to determine which of the possible digital events to trigger. A triggered digital event may also be personalized to include one or more pieces of information about the user, such as but not limited to the user's name or gender.

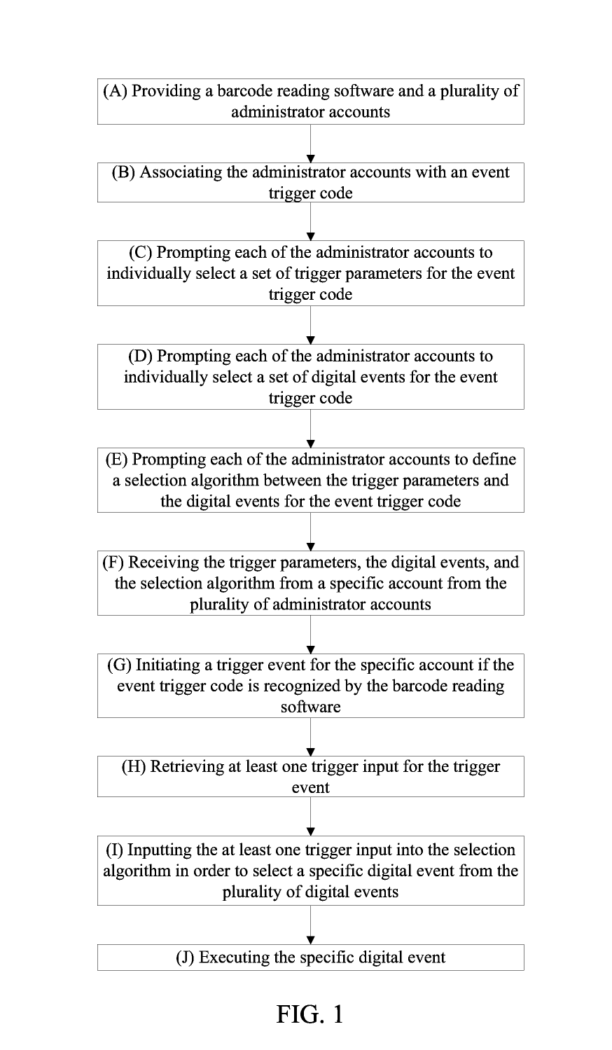

In the process of the present invention as shown in FIG. 1, a barcode reading software and a plurality of administrator accounts are provided. The administrator accounts are associated with an event trigger code. The event trigger code is any information ascertained through scanning a QR code or other relevant barcode or information with the user's smartphone. By scanning the QR code and reading the event trigger code, the present invention ascertains which administrator or group of administrators to retrieve the customized parameters of.

Initially to set the administrator customization, each of the administrator accounts is prompted to individually select a set of trigger parameters for the event trigger code. The trigger parameters reflect any relevant parameters or variables the administrator wishes to customize delivery of digital events though. Such trigger parameters may relate to, but are not limited to, user attributes, location, time, sequence, and random numbers. Each of the administrator accounts is also prompted to individually select a set of digital events for the event trigger code. This is the set of possible digital events the administrator may draw from for utilizing the present invention. Additionally each of the administrator accounts is prompted to define a selection algorithm between the trigger parameters and the digital events for the event trigger code. The selection algorithm links the trigger parameters and the digital events according to the customization preferences set by the administrator.

On an individual level, the trigger parameters, the digital events, and the selection algorithm are received by the system from a specific account from the plurality of administrator accounts.

Subsequently, the end user scans a dynamic QR code with their smartphone. A trigger event for the specific account is initiated if the event trigger code is recognized by the barcode reading software on the user's smartphone. The trigger event refers to the fact that the dynamic QR code has been scanned and will subsequently trigger a digital event. At least one trigger input is received for the trigger event. Trigger inputs refer to the collection of variables which can affect which digital event is triggered and are counterparts to the trigger parameters, potentially relating to, but not being limited to, user attributes, location, time, sequence, and random numbers. The at least one trigger input is inputted into the selection algorithm in order to select a specific digital event from the plurality of digital events, and subsequently the specific digital event is executed.

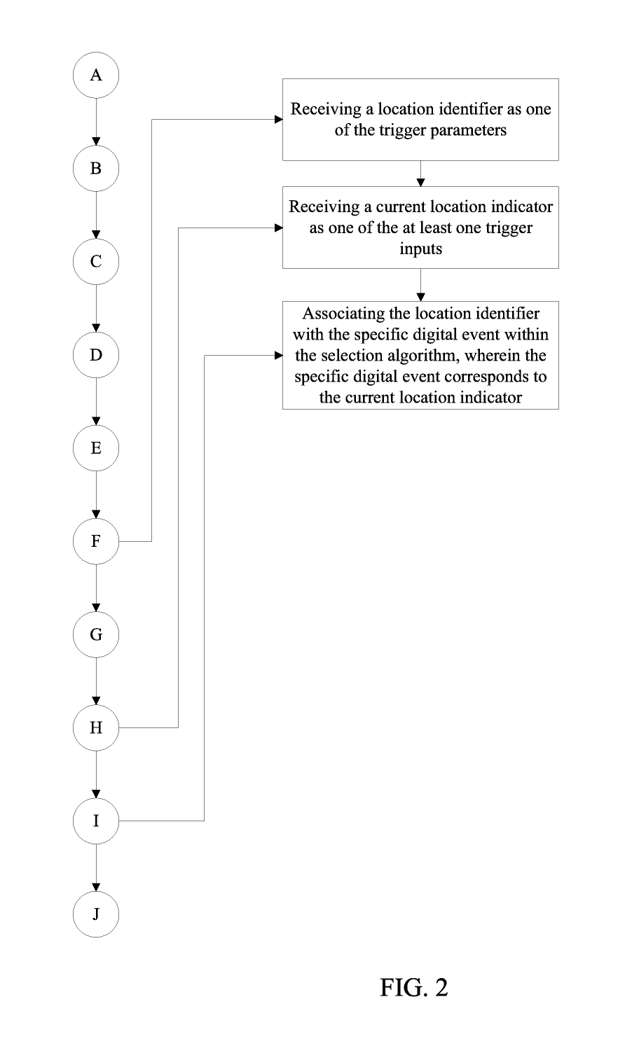

As shown in FIG. 2, in one case, a location identifier is received as one of the trigger parameters, and a current location indicator is received as one of the at least one trigger inputs. The location identifier is associated with the specific digital event within the selection algorithm, wherein the specific digital event corresponds to the current location indicator. What this means is that an administrator may designate certain digital events to be delivered at certain locations.

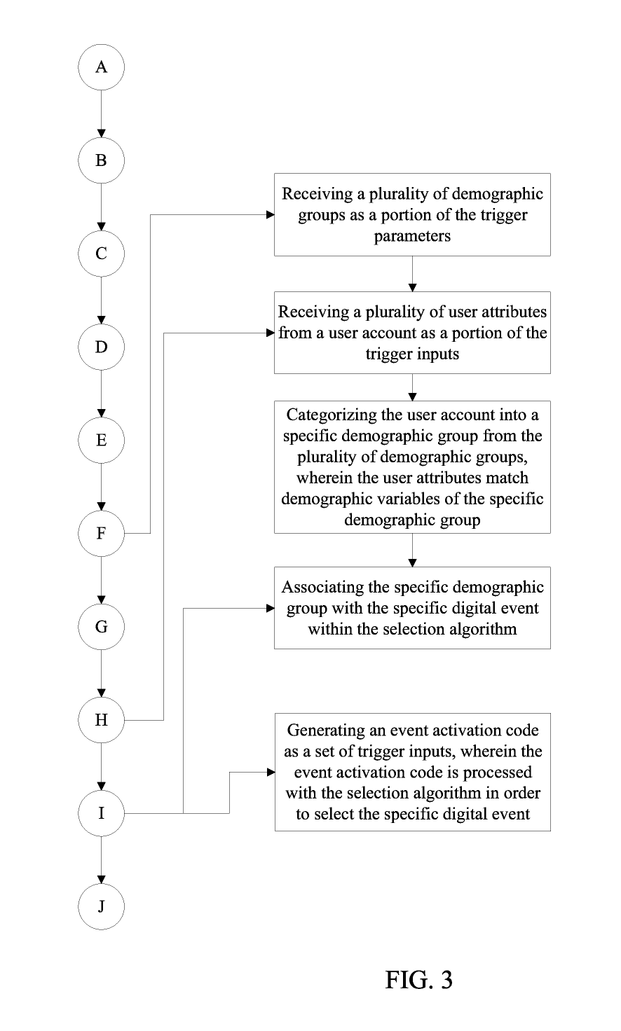

In another case shown in FIG. 3, a plurality of demographic groups are received as a portion of the trigger parameters, and a plurality of user attributes are received from a user account as a portion of the trigger inputs. The user account is a collection of data, including but not limited to user login credentials, user attributes, and action and interaction history logs, specifically associated with a specific end-user. In the preferred embodiment of the present invention, the user account is created on the smartphone (on-device) to facilitate storage and retrieval of user information by the barcode reading software. In other words, there is no way to retrieve the inputted user information and other history and information that are written and used by the software, such as sequencing event logs data, if the user loses the smartphone or if the user's device is infiltrated by a third party. The user account is then categorized into a specific demographic group from the plurality of demographic groups, wherein the user attributes match demographic variables of the specific demographic group. The specific demographic group is then associated with the specific digital event within the selection algorithm. What this means is that an administrator may designate certain digital events to be delivered to users with certain demographic attributes.

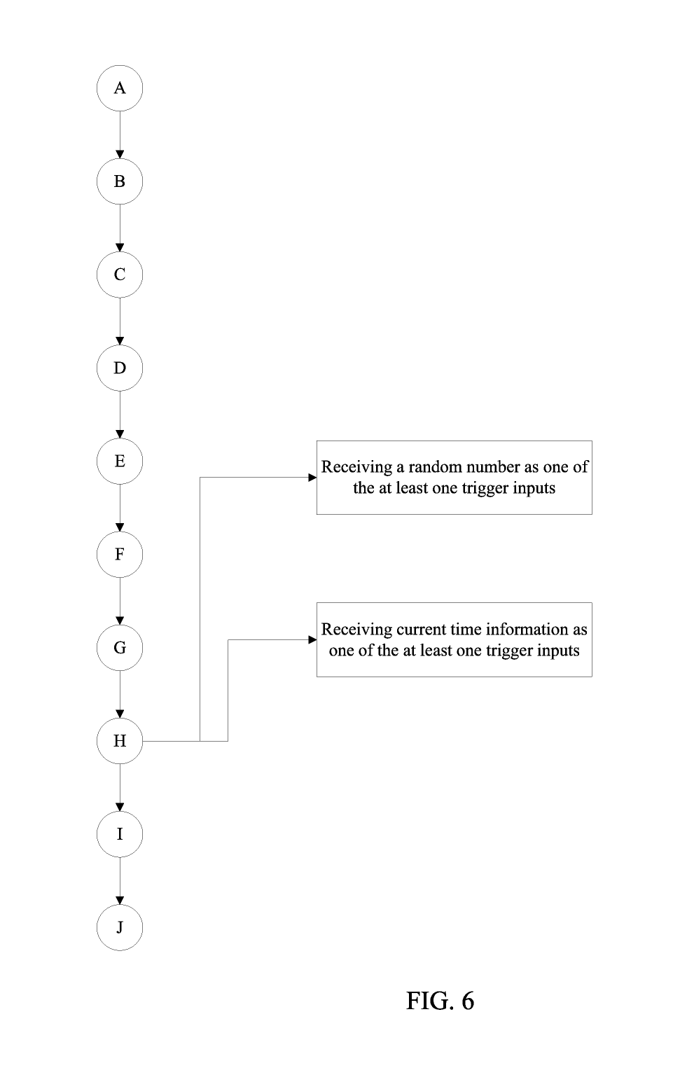

In other cases as shown in FIG. 6, a random number may be received as one of the at least one trigger inputs if a corresponding trigger parameter is defined by the administrator. The administrator may wish to incorporate randomness into the delivery of the digital events, so that different digital events may be delivered when all other variables are equal. Similarly, current time information may be received as one of the at least one trigger inputs. In this case, the administrator may specify different digital events to be delivered at different times, all other variables being equal.

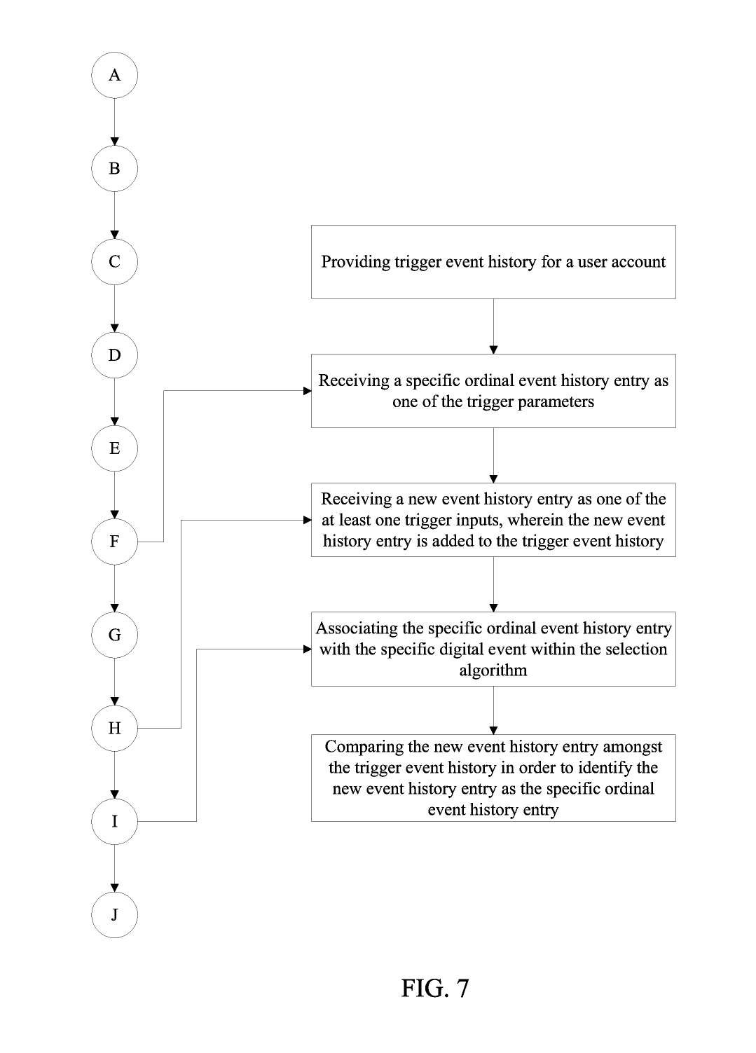

In another described in FIG. 7, a sequence of trigger events may be utilized to deliver a digital event. As such, a trigger event history is collected for the user account and provided. In this case, a specific ordinal event history entry is received as one of the trigger parameters. The specific ordinal event history entry defines a location index in a sequence of trigger events at which to execute a digital event. In a non-limiting example, the specific ordinal event history may define that the 5^{th} time a user scans a dynamic QR code, the user is presented with a digital event such as free product or coupon. In this case, a new event history entry is received as one of the at least one trigger inputs, wherein the new event history entry is added to the trigger event history. The specific ordinal event history entry is associated with the specific digital event within the selection algorithm. The new event history entry is compared amongst the trigger event history in order to identify the new event history entry as the specific ordinal event history entry. In other words, in this case the present invention is checking to see whether the current trigger event corresponds to the required number of scans in the sequence.

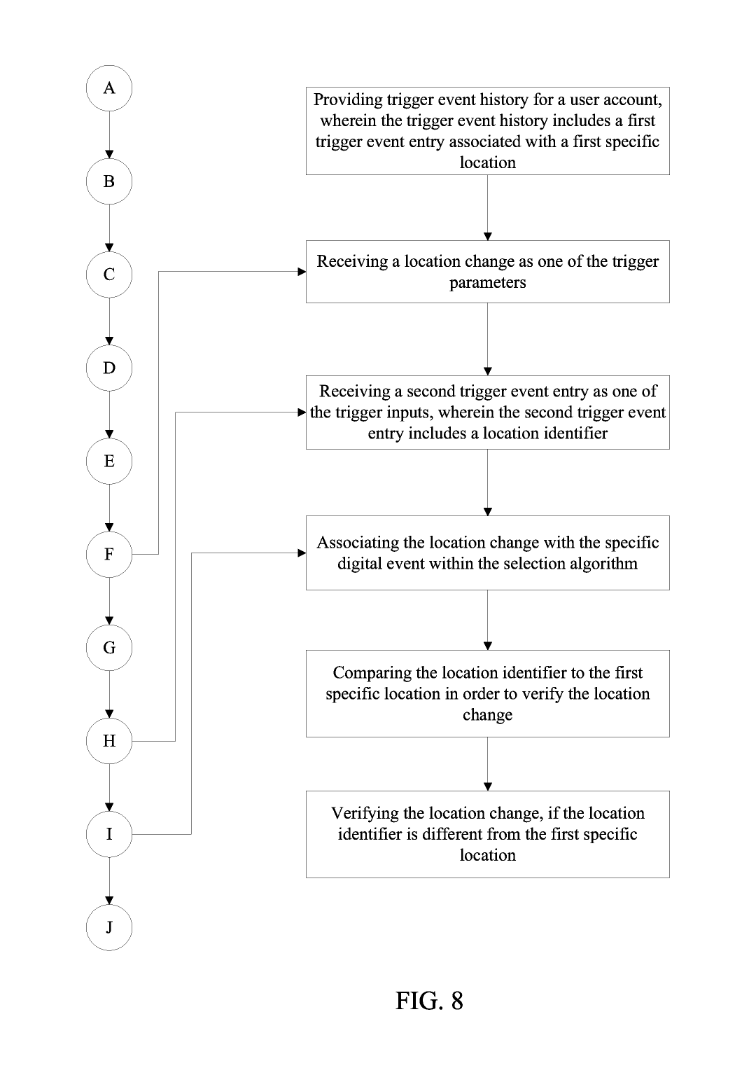

In another case involving a sequence described in FIG. 8, a digital event may be designated to be delivered following a location change. In this case the trigger event history includes a first trigger event entry associated with a specific location, and a location change is received from an administrator as one of the trigger parameters. A second trigger event entry is then received as one of the trigger inputs, wherein the second trigger event entry includes a location identifier. The location change is associated with the specific digital event within the selection algorithm. The location identifier of the second trigger event entry is compared to the first specific location in order to verify the location change. The location change is verified of the location identifier is different from the first specific location.

The aforementioned trigger parameters and corresponding trigger input scenarios can potentially be used in any combination as desired by the administrator.

In the preferred embodiment of the present invention, an event activation code is generated as a set of trigger inputs, wherein the event activation code is processed with the selection algorithm in order to select the specific digital event.

In the preferred embodiment, user attributes are received from a user account, as well as a current location indicator. The current location indicator may be retrieved from a GPS module of the user's smartphone, or the user account may be prompted to input the current location indicator, or the current location indicator may be obtained by any other relevant and useful means, such as, but not limited to, recognizing a wireless signal such as a Wi-Fi or Bluetooth signal, or a radio frequency identification (RFID) tag, or any other means. The location indicator may utilize altitude to differentiate between locations at the same geographical location but at different altitudes, such as locations at different floors in a building.

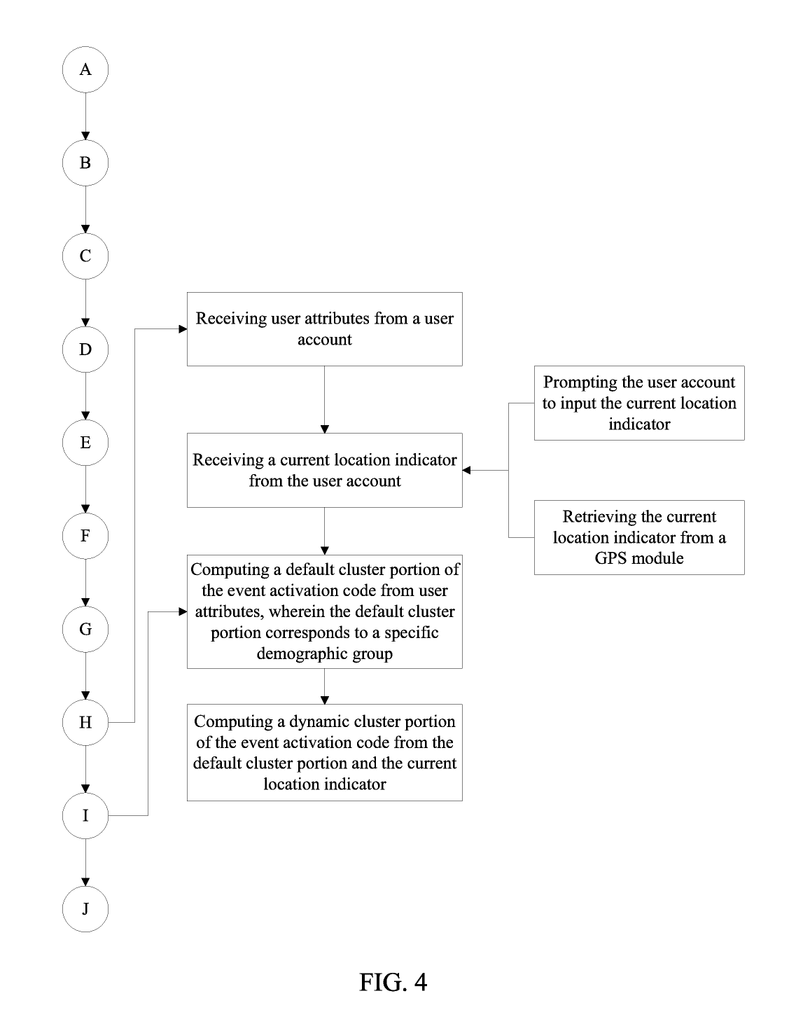

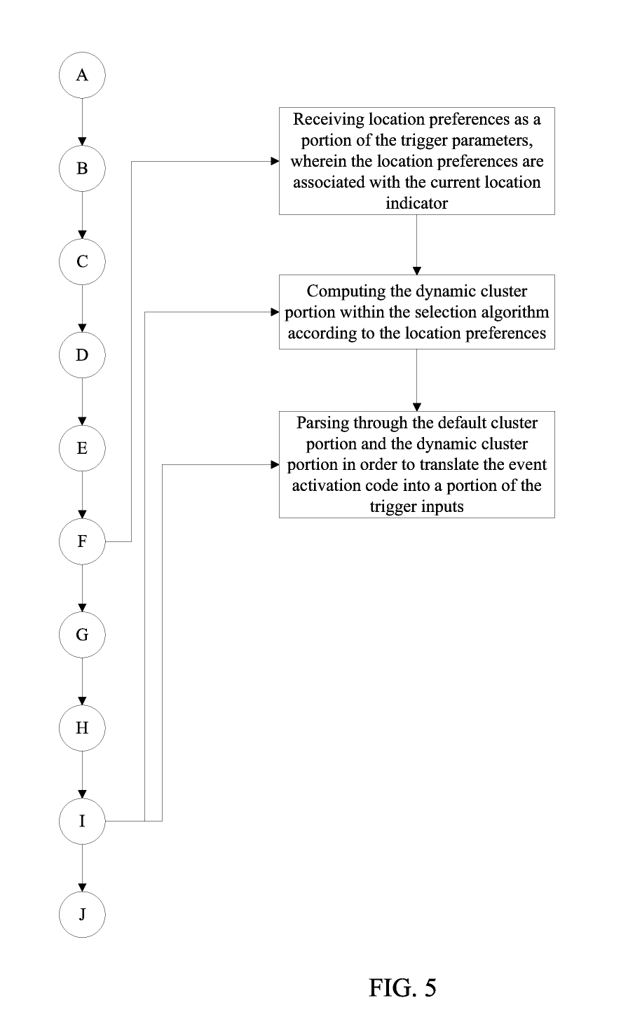

Referring to FIGS. 4-5, a default cluster portion of the event activation code is computed from the user attributes, wherein the default cluster portion corresponds to a specific demographic group as designated by the administrator. A dynamic cluster portion of the event activation code is computed from the default cluster portion and the current location indicator, additionally taking into account the trigger parameters. Location preferences are received as a portion of the trigger parameters, wherein the location preferences are associated with the current location indicator. The dynamic cluster portion is computed within the selection algorithm according to the location preferences. The location preferences are designated by the administrator associated with the current location indicator in order to specify demographic filtering preferences at the location of the current location indicator. The location preferences may be used, in a non-limiting example, by an individual franchise of a chain restaurant. While the chain as a whole may have designated overall trigger parameters, the franchise may override the specific trigger parameters with specific trigger parameters for the specific location. Once the event activation code is received, the default cluster portion and the dynamic cluster portion are parsed through in order to translate the event activation code into the trigger inputs or a portion of the trigger inputs.

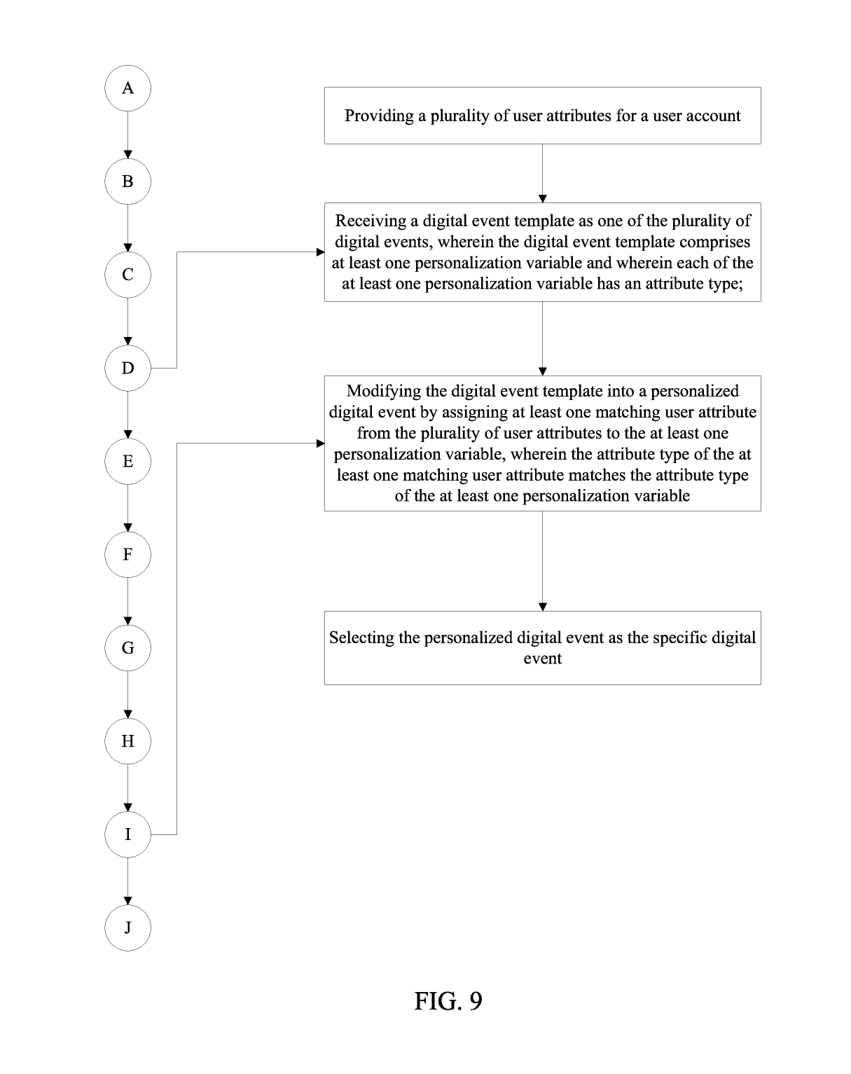

One additional feature of the present invention is enabling digital events which are personalized to the user. Providing that a plurality of user attributes for a user account are received, a digital event template is received as one of the plurality of digital events as described in FIG. 9. The digital event template comprises at least one personalization variable, and each of the at least one personalization variable has an attribute type. The digital event template is modified into a personalized digital event by assigning at least one matching user attribute from the plurality of user attributes to the at least one personalization variable, wherein the attribute type of the at least one matching user attribute matches the attribute type of the at least one personalization variable. In other words, the correct attribute type should be assigned to the correct personalization variable. In a non-limiting example, a user attribute and personalization variable share the attribute of age. The user attribute is the actual value of the user's age, and the personalization variable is where the user attribute is used. The personalized digital event is then selected as the specific digital event.

One important aspect of the present invention to note is that end user information is never transmitted out from the user's smartphone. The user information is interpreted by the software on the smartphone in order to produce the event activation code, which is transmitted to a server of the present invention for interpretation. It is important to note that the event activation code does not indirectly transmit personal details about the user, such as their name or birthdate. The user attributes are simply interpreted in order to assign a predetermined demographic group to the user. The information designating this demographic group is what is transmitted, not the user attributes themselves. Thus, even if a third party was able to intercept the event activation code, they could not decipher the user's personal details, thus preserving their security and identity. Additionally, the event activation code may be further encrypted before transmission for an additional layer of security.

The present invention offers a wide range of customizability to businesses and other potential clients. The present invention allows a huge variety of digital events to be triggered under a large range of customizable circumstances, based on a number of variables such as age, gender, location, sequence, and randomness. The following examples should be understood to be non-limiting.

Firstly, the present invention allows different digital events to be delivered at different locations. For example, a fast-food chain distributes the same dynamic QR code to 50 outlets where each outlet can customize their own set of digital events. In another example, a fashion apparel chain with 25 outlets under one fashion brand and 15 outlets under another brand distributes the same QR code to all 40 outlets where both brands are able to customize their own set of digital events, or QR events, and each outlet in turn is able to further customize its own QR events.

Different digital events may also be delivered at the same location. In an example of an event sequence, a café offers a soda the second time a customer scans the QR code who received a coffee the first time they scanned the code. In another example of an event sequence incorporating date and time, the café further offers cake on the third scan in the morning, or chocolates on the third scan for customers who have previously received both coffee and soda.

In another example using elevation or altitude information, a café on the third floor of a building offers cheesecake on the first scan of their QR code, while the café on the first floor of the building offers chocolate cake on the first scan of their QR code. In another example utilizing location history, a café offers an apple to users traveling from another location to the north, while users traveling from another location to the south are offered an orange. The location history can be ascertained through multiple scans or through an always-on location monitoring feature such as GPS. In another example, a fast-food chain offers salad and fruit to customers on the fifth and 15^{th} times one of the chain's QR codes are scanned by a customer, wherein said scans may be performed at any of the chain's 50 outlets.

Another primary use of the present invention is to deliver dynamic and customizable digital events through user attributes. The default cluster portion as described above is assigned through interpreting inputted user attributes. The dynamic cluster is generated from the default cluster and the trigger parameters designated by the administrator, which are essentially preferences for what digital event to deliver where to what demographic group under what circumstances. The event activation code may also include a random code which can add randomness to digital event delivery if the administrator so desires.

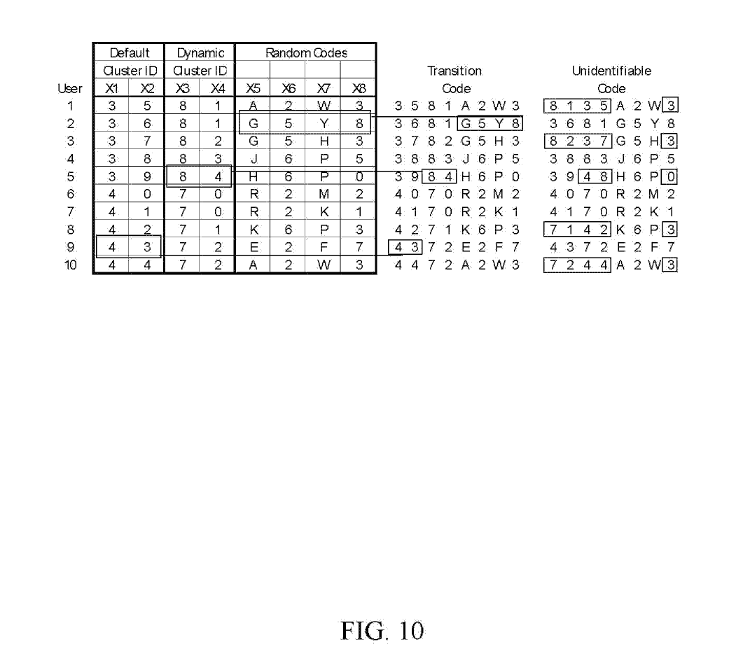

Administrator preferences can be set so that different digital events are delivered based on the default cluster portion, and/or on the dynamic cluster portion. Consider the table presented in FIG. 10. For the purposes of illustration, consider that the present invention creates the event activation code in order X1 to X8, where X1 through X8 are digits in the event activation code. If the administrator desires, each different cluster portion can be delivered different digital events. Therefore, users 1 through 10 are delivered different events. The administrator may also designate different digital events based on the dynamic cluster portion. Therefore users 1 and 2 are delivered the same digital event for dynamic cluster 81, users 6 and 7 are delivered the same digital event for dynamic cluster 70, and users 9 and 10 are delivered the same event for cluster number 72.

Combining the previous uses, a variety of permutations may be utilized with location, user attributes and a random code. As per the previous description, different digital events may be delivered: at different locations, for different user attributes at the same location, and for the same user attributes at the same location. Additionally, the same digital event may be delivered: across different locations, for the same user attributes across different locations, and for different user attributes at the same location. In the example table presented, the “unidentifiable code” is an encrypted version of the “transition code” created by switching various digits of the transition code.

It is one object of the present invention to allow multiple levels of control over the customization of the trigger parameters. For example, a fast-food chain may designate parameters for all branches, but an individual franchise may be able to override the global chain parameters.

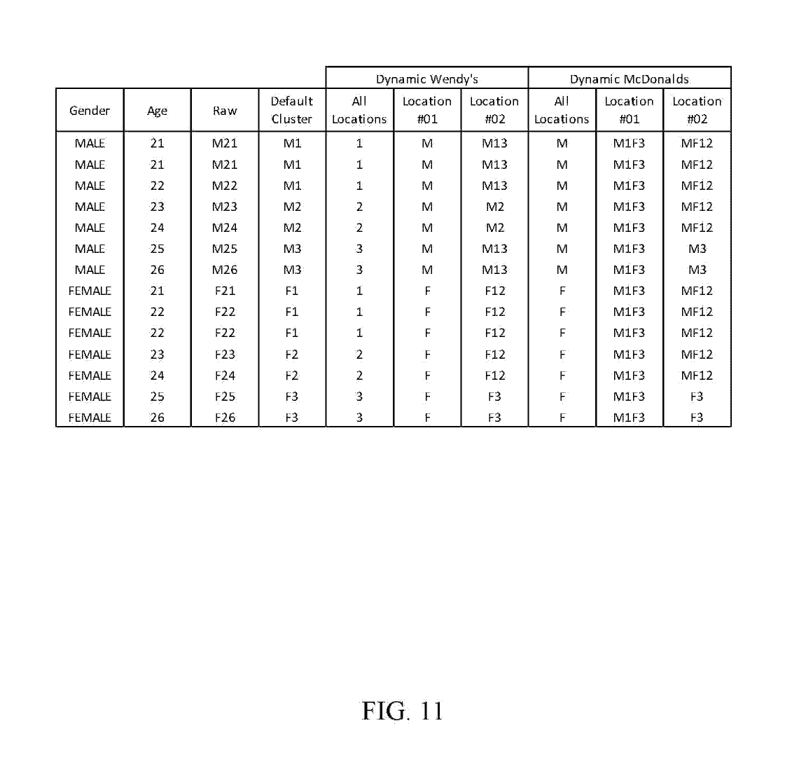

Consider the table presented in FIG. 11. Users are grouped by gender and age: male 21-22, 23-24, and 25-26, and similarly female 21-22, 23-24, and 25-26. The “RAW” value in this table represents the aggregation of “building blocks” or all potential variables to consider. M21 represents a 21 year old male, and F24 represents a 24 year old female. The “raw” data is filtered into the predetermined demographics groups—three groups for males and three for females. The global parameters for Wendy's are set to customize digital events by age only—thus reducing the potential pool of groups to 3 separated by age as applied to all locations. Since the default cluster only includes gender and group information, the business is not able to differentiate between 21 year olds and 22 year olds, for example, since they belong to the same group.

Two specific locations, however, choose to override the global parameters. The first location chooses to split digital event deliver by gender instead of age. The system is able to do this by reading the default cluster, which contains not only the age group information but also the gender information.

The second location wishes to split up the groups differently. The second location puts the first male group and the third male group together, as well as the first female group and the second female group, allowing four different digital events to be displayed to four different groups.

Although the invention has been explained in relation to its preferred embodiment, it is to be understood that many other possible modifications and variations can be made without departing from the spirit and scope of the invention as hereinafter claimed.

What is claimed is:

1. A method of delivering personalized digital events from a single scannable two-dimensional barcode by executing computer-executable instructions stored on a non-transitory computer-readable medium comprises the steps of:
providing a barcode reading software and a plurality of administrator accounts;
associating the administrator accounts with an event trigger code;
prompting each of the administrator accounts to individually select a set of trigger parameters for the event trigger code;
prompting each of the administrator accounts to individually select a set of digital events for the event trigger code;
prompting each of the administrator accounts to define a selection algorithm between the trigger parameters and the digital events for the event trigger code;
receiving the trigger parameters, the digital events, and the selection algorithm from a specific account from the plurality of administrator accounts;
initiating a trigger event for the specific account if the event trigger code is recognized by the barcode reading software;
retrieving at least one trigger input for the trigger event;
inputting the at least one trigger input into the selection algorithm in order to select a specific digital event from the plurality of digital events;
executing the specific digital event;

2. The method of delivering personalized digital events from a single scannable two-dimensional barcode by executing computer-executable instructions stored on a non-transitory computer-readable medium as claimed in claim 1 comprises the step of:
receiving a location identifier as one of the trigger parameters;
receiving a current location indicator as one of the at least one trigger inputs;
associating the location identifier with the specific digital event within the selection algorithm, wherein the specific digital event corresponds to the current location indicator;

3. The method of delivering personalized digital events from a single scannable two-dimensional barcode by executing computer-executable instructions stored on a non-transitory computer-readable medium as claimed in claim 1 comprises the step of:
receiving a plurality of demographic groups as a portion of the trigger parameters;
receiving a plurality of user attributes from a user account as a portion of the trigger inputs;
categorizing the user account into a specific demographic group from the plurality of demographic groups, wherein the user attributes match demographic variables of the specific demographic group;
associating the specific demographic group with the specific digital event within the selection algorithm;

4. The method of delivering personalized digital events from a single scannable two-dimensional barcode by executing computer-executable instructions stored on a non-transitory computer-readable medium as claimed in claim 1 comprises the step of:
generating an event activation code as a set of trigger inputs, wherein the event activation code is processed with the selection algorithm in order to select the specific digital event;

5. The method of delivering personalized digital events from a single scannable two-dimensional barcode by executing computer-executable instructions stored on a non-transitory computer-readable medium as claimed in claim 4 comprises the step of:
receiving user attributes from a user account;
receiving a current location indicator from the user account;
computing a default cluster portion of the event activation code from user attributes, wherein the default cluster portion corresponds to a specific demographic group;
computing a dynamic cluster portion of the event activation code from the default cluster portion and the current location indicator;

6. The method of delivering personalized digital events from a single scannable two-dimensional barcode by executing computer-executable instructions stored on a non-transitory computer-readable medium as claimed in claim 5 comprises the step of:
receiving location preferences as a portion of the trigger parameters, wherein the location preferences are associated with the current location indicator;
computing the dynamic cluster portion within the selection algorithm according to the location preferences;

7. The method of delivering personalized digital events from a single scannable two-dimensional barcode by executing computer-executable instructions stored on a non-transitory computer-readable medium as claimed in claim 5 comprises the step of:
parsing through the default cluster portion and the dynamic cluster portion in order to translate the event activation code into a portion of the trigger inputs;

8. The method of delivering personalized digital events from a single scannable two-dimensional barcode by executing computer-executable instructions stored on a non-transitory computer-readable medium as claimed in claim 5 comprises the step of:
prompting the user account to input the current location indicator;

9. The method of delivering personalized digital events from a single scannable two-dimensional barcode by executing computer-executable instructions stored on a non-transitory computer-readable medium as claimed in claim 5 comprises the step of:
retrieving the current location indicator from a GPS module;

10. The method of delivering personalized digital events from a single scannable two-dimensional barcode by executing computer-executable instructions stored on a non-transitory computer-readable medium as claimed in claim 1 comprises the step of:
receiving a random number as one of the at least one trigger inputs;

11. The method of delivering personalized digital events from a single scannable two-dimensional barcode by executing computer-executable instructions stored on a non-transitory computer-readable medium as claimed in claim 1 comprises the step of:
receiving current time information as one of the at least one trigger inputs;

12. The method of delivering personalized digital events from a single scannable two-dimensional barcode by executing computer-executable instructions stored on a non-transitory computer-readable medium as claimed in claim 1 comprises the step of:
providing trigger event history for a user account;
receiving a specific ordinal event history entry as one of the trigger parameters;
receiving a new event history entry as one of the at least one trigger inputs, wherein the new event history entry is added to the trigger event history;
associating the specific ordinal event history entry with the specific digital event within the selection algorithm;
comparing the new event history entry amongst the trigger event history in order to identify the new event history entry as the specific ordinal event history entry;

13. The method of delivering personalized digital events from a single scannable two-dimensional barcode by executing computer-executable instructions stored on a non-transitory computer-readable medium as claimed in claim 1 comprises the step of:
providing trigger event history for a user account, wherein the trigger event history includes a first trigger event entry associated with a first specific location;
receiving a location change as one of the trigger parameters;
receiving a second trigger event entry as one of the trigger inputs, wherein the second trigger event entry includes a location identifier;
associating the location change with the specific digital event within the selection algorithm;
comparing the location identifier to the first specific location in order to verify the location change;
verifying the location change, if the location identifier is different from the first specific location;

14. The method of delivering personalized digital events from a single scannable two-dimensional barcode by executing computer-executable instructions stored on a non-transitory computer-readable medium as claimed in claim 1 comprises the steps of:
providing a plurality of user attributes for a user account;
receiving a digital event template as one of the plurality of digital events,
wherein the digital event template comprises at least one personalization variable;
wherein each of the at least one personalization variable has an attribute type;
modifying the digital event template into a personalized digital event by assigning at least one matching user attribute from the plurality of user attributes to the at least one personalization variable, wherein the attribute type of the at least one matching user attribute matches the attribute type of the at least one personalization variable;
selecting the personalized digital event as the specific digital event;
